(19) United States
(12) Patent Application Publication
(10) Pub. No.: US 2012/0205302 A1
(43) Pub. Date: Aug. 16, 2012

(54) Filtration Unit System

(75) Inventor: Ross Leslie Palmer, Mt Gravatt (AU)

(73) Assignee: POOLRITE RESEARCH PTY LTD, MT GRAVATT, QL (AU)

(21) Appl. No.: 13/393,958

(22) PCT Filed: Sep. 2, 2010
(86) PCT No.: PCT/AU2010/001133

§ 371 Date: May 2, 2012

(30) Foreign Application Priority Data
Sep. 2, 2009 (AU) 2009904206

(51) Int. Cl. E04H 4/16; B23P 11/00; E04H 4/14; C02F 1/76

(52) U.S. Cl. 210/167.11; 210/167.1; 210/167.12; 29/428; 248/346.03

(57) ABSTRACT

A filtration unit for a swimming pool or spa, is disclosed, the filtration unit including a support base (20); a filter housing (30) mounted on top of the support base; and a recess (21) in the support base, the recess adapted to receive a pump (60), at least in part. A multi-port valve (50) is laterally mounted to the filter housing wherein an orbital control arm (54) of the multi-port valve may be moved in a substantially vertical plane to select alternative operations of the filtration unit. The unit may further include a top with space for electronic controls and/or chemicals.

### FIELD OF THE INVENTION

This invention relates to a filtration unit and in particular water filtration unit used for domestic swimming pools and spas and the like.

### BACKGROUND OF THE INVENTION

The basis of a domestic swimming pool filtration system includes a series of pipes connected to a pump to draw water from a pool. Unfiltered water first enters a pump strainer basket before passing through the impeller of the pump to a filter. The pump strainer basket ensures that large particles do not get trapped in the impeller and stall a motor of the pump.

Unfiltered water passes from the pump, to the filter and filtered water exits the filter and is returned to the pool via a further series of pipes. As part of the filtering process, a media filter must be periodically “backwashed” or in the case of a cartridge filter the cartridge must be periodically replaced or cleaned. Backwashing involves changing an operating mode of the filter by passing water in the reverse direction to filtration using a multi-port valve. The multi-port valve is typically connected to a top of the filter.

During installation of the pool, a plumber installs pipes between the pool, pump, multi-port valve and filter as is known in the art. The resulting series of pipe connections results in a “rats nest” of pipes which is visually untidy and includes an abundance of bends which increase resistance to water flow. Consequently, the filtration equipment is either installed inside an out building or a purpose built shelter is constructed. The shelter may also serve as a store for chemicals required for the pool. Furthermore, the equipment shelter also acts to suppress the noise of a motor of the pump. A problem of existing horizontally mounted multi-port valves on the top of the filter is that they are awkward to operate and as a result interconnecting pipes are subject to being knocked and damaged and may result in costly repairs. They also tend to collect water, such as from wind blown rain which can cause deterioration of selector indications or surrounds.

Further, as part of a maintenance regime, water in the pool needs to be carefully monitored to ensure that the pool remains within tight ranges of parameters. Two of these parameters are pH level and chlorine concentration, to ensure the health and safety of people using the pool. Furthermore, if the pH level and chlorine concentration are not tightly controlled, the pool attracts algae and may go cloudy and/or green.

To adjust the pH and chlorine concentration it is necessary to first test the pool and then add the appropriate chemical to bring the parameters within an optimum range. A common method of adding chemicals to the water is to add the chemical directly to the pool however this has associated risks. The chemicals used to compensate the pH and chlorine level are caustic and commonly splash back towards an operator when poured into a large volume of water. Although automatic dosing units are available, they are expensive to buy and liable to malfunction.

A further problem arises from noise emanating from the pool pump in operation. This may be exaggerated if a second pump, such as for a solar heating system, is added to the system.

US Patent Application No 2004/0173517 to Yuan is for A Water Filter and Pump Assembly. The disclosure is to a pump casing having mounted therein an electric motor driving an impeller within a impeller housing. A filter casing is mounted directly on top of the pump casing of the water outlet. The combination is designed to provide a compact water filter and pump combination with shielding for the filter elements from direct high velocity impingement water from the pump. The pump casing is simply a modified pump arrangement with restricted access to the motor and impeller. An access and ventilation plate mounted on the bottom of the pump case provides access to the motor for servicing. The invention is therefore to a modified pump and impeller arrangement wherein the pump casing is adapted to provide direct water flow to the filter. The arrangement would be difficult to access for maintenance and require disassembly for any significant work on the motor and impeller.

U.S. Pat. No. 4,022,690 to Smith is for An Integral Pump Skimmer and Filter Unit for Aboveground Swimming Pools. A centrifugal pump is mounted vertically below a filter and skimmer assembly on a pump mounting plate. A channel-shaped enclosure is positioned around the assembly abutting a wall of the aboveground pool. In operation, maintenance of the pump would require removal of the channel-shaped enclosure and dismounting of the pump unit from the mounting plate and plumbing attachment.

UK Patent Application No 2325179 to Sunbeam Products, Inc., is for A Potable Water Filtration Device incorporating a Pump. It describes a container and housing with a pump, filter cartridge and filtered water outlet. As noted in the specification, the invention relates to filters for domestic or office use which are used to further purify already potable water. The arrangement is simply not suitable for any sort of application with a swimming pool or spa. It has restricted capacity to provide glasses of filtered water for consumption.

Chinese Patent Application No 2931674 describes a swimming pool filter structure with a body, a base, a top cover, a filter element, an electrical apparatus box and an electric bar. The base is a support body with the lower portion larger than the upper portion wherein a motor body is arranged inside the support body with a water outlet. It describes a motor fixed inside the base unit which would require disassembly of the whole unit to access the motor for any basic maintenance purposes.

### OBJECT OF THE INVENTION

It is an object of the invention to overcome or alleviate one or more of the above disadvantages and/or to provide the consumer with a useful or commercial choice.

### SUMMARY OF THE INVENTION

In one form, although it need not be the only or indeed the broadest form, the invention resides in a filtration unit for a swimming pool or spa, the filtration unit including:

a support base;

a filter housing mounted on top of the support base; and

a recess in the support base, the recess adapted to receive a pump, at least in part.

The filtration unit may further comprise a multi-port valve laterally mounted to the filter housing wherein an orbital control arm may be moved in a substantially vertical plane to select alternative operations of the filtration unit.

Preferably, at least one pump is mounted to or positioned in the support base. Most preferably, the at least one pump is positioned in the recess formed within the support base. The recess is preferably dimensioned to receive the pump motor with a pump strainer basket in fluid connection with the pump and the impeller portion of the pump outside and adjacent the support base.

A second pump may be positioned within a second recess which may be continuous with the recess. Each recess is preferably vented to allow heat dissipation. The recess and second recess may form a continuous tunnel along a longitudinal axis of the support base.

The support base is preferably formed from a sound reducing material such as a polymeric plastic which is also resistant to environmental conditions. A suitable material may be polypropylene, polyethylene or ABS (acrylonitrile butadiene styrene).

A top may be positioned on and/or above the filter housing. The top may be formed as one or more cabinets. Preferably at least one of the one or more cabinets is vented to allow dissipation of volatile gases and odours. The one or more cabinets may each have a door. Most preferably each door includes a lock and is dimensioned to receive pool chemicals in their containers. In one embodiment the door or doors may have one or more electronic locks. The locks may be activated when power is provided to the pump and/or controls for the pump (i.e., the system is energized). An override release switch may be provided to allow operation of the one or more doors.

The filter housing may contain any suitable filtering arrangement such as a media filter, cartridge filter or centrifugal filter.

Suitably, the filter housing is substantially a prolate spheroid in shape.

Optionally, the filtration unit also includes a cyclonic filter.

Preferably, the filter housing includes a chemical port to allow chemicals to be added directly to the filter.

The chemical port may be positioned in or adjacent the multi-port valve. Alternatively, if the multi-port valve is vertically orientated, the chemical port may be positioned on a top surface of the filter housing. The chemical port may have a particular, selected cross section which conforms to a cross sectional shape of a tabletised chemical for addition to the filter.

Optionally, the filtration unit includes more than one filter housing, wherein each filter housing is connected by a joining section to provide fluid communication between them. The filters may be arranged vertically one above the other.

The filtration unit may further comprise an auxiliary cover to provide extra coverage of components external to the support base, such as the pump strainer basket.

In another form, the invention resides in a filter housing for a swimming pool the filter housing including:

a chemical port providing direct access to a filtration medium in the filter housing and to liquid within the filter.

In yet another form, the invention may reside in a media filter housing for a swimming pool including:

at least one swept ninety degree bend used for internal connections of the media filter, the at least one swept bend formed between lateral collecting lateral arms and/or an outlet from the filter housing and/or an inlet and a diffuser.

In another form, the invention may reside in an arrangement of a multi-port valve for a swimming pool including:

a plurality of ports in the multi-port valve; and

an orbital arm positioned and operable in a vertical plane wherein the orbital arm selects the flow of water between one or more of the plurality of ports.

In yet another form, the invention resides in a method of operating a multi-port valve including the step of:

positioning the multi-port valve with an orbital arm rotatable in a vertical plane, and moving the orbital arm of the multi-port valve in a substantially vertical plane between a plurality of positions wherein each position is a different mode of operation.

In still another form the invention may reside in a method of decreasing external noise, at least in part, of one or more pumps in a filtration arrangement for a swimming pool or spa, the method including the steps of:
a) positioning the one or more pumps, at least partially, within one or more recesses in a support base; and
b) locating a housing for a filtration medium above and supported by the support base.

In still another form, the invention may reside in a support base for a filtration unit, for a swimming pool, spa the support base comprising a body, the body having at least one recess adapted to receive at least one pump or part thereof; and

an upper cradle said cradle adapted to receive a filter.

The support base and filter, in operation, preferably are adapted to limit noise transmission from the pump or pumps to the environment external to the recess.

### BRIEF DESCRIPTION OF THE DRAWINGS

An embodiment of the invention, by way of example only, will be described with reference to the accompanying drawings in which:

FIG. 1 is a front perspective view of a filtration unit of the present invention;

FIG. 2 is a sectional front view of a filter of the filtration unit of FIG. 1;

FIG. 3A is a front perspective view of a filtration unit, including a lid;

FIG. 3B is a front perspective view of a filtration unit, including a lid and open hatch;

FIG. 4 is a front sectional view of a filtration unit according to a further embodiment of the present invention including two pumps;

FIG. 5 is a front view of a swimming pool filtration unit including two filters stacked one above the other;

FIG. 6 is a front perspective view of a swimming pool filtration unit including a centrifugal filter; and

FIGS. 7A and 7B are rear perspective views of filtration units including respective covers.

### DETAILED DESCRIPTION OF THE PREFERRED EMBODIMENT

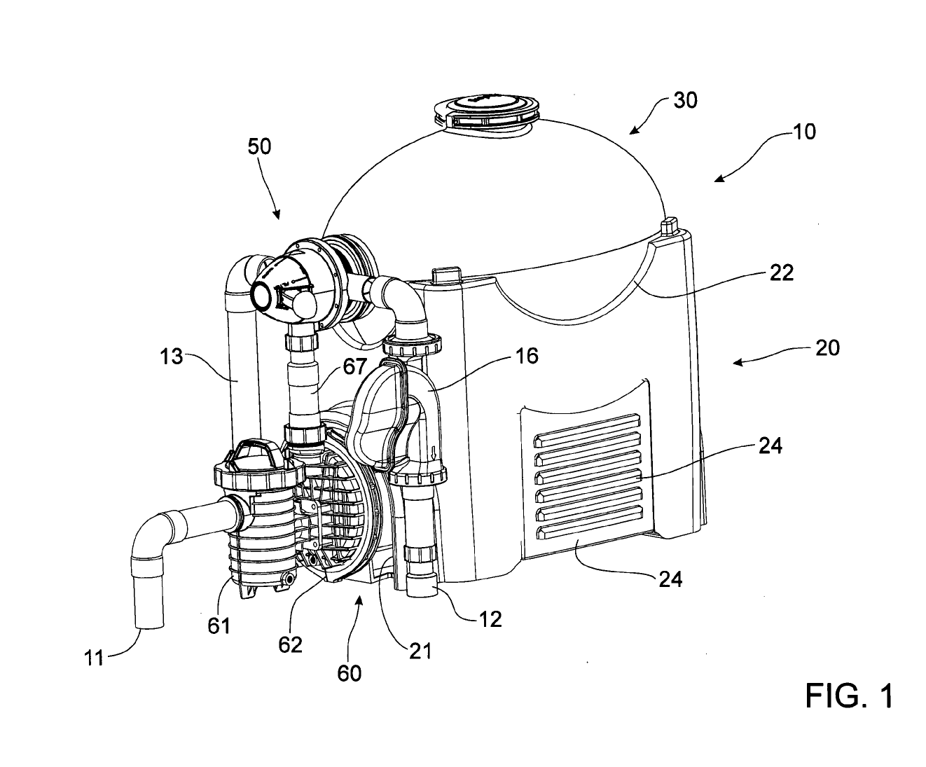

FIG. 1 shows a front view of a filtration unit 10 according to the present invention including a support base 20, a filter housing 30, a multi-port valve 50 and a pump 60.

The support base 20 is made from a plastic material such as ABS however any suitable material may be used, for example, fibreglass. The material should be hardwearing and sound dampening to provide the twin benefits of protection from the elements and decreased noise. The support base 20 may be moulded to form a cradle 22 to accept the filter housing 30 which is mounted on the support base 20. The support base and filter housing may be formed integrally or as separate units, as preferred. In one embodiment, an upper surface of the support base may form a lower surface of the filter housing. Furthermore, the support base 20 includes a recess 21 dimensioned to accept the pump 60. In this case the recess receives a majority of the pump and particularly the pump motor. The recess is formed as an open, cave like structure of a size to receive the pump. The pump comprises a motor and impeller 62 both including an external shell. In one embodiment the support base may form the external shell for the pump motor. Generally, it is preferred that the recess is dimensioned to receive a conventional pump, or at least the motor. The impeller and its external shell 62 may be positioned externally to the recess. This provides close apposition of the impeller and connecting pipe 67 to multi-port valve 50. It is to be understood that the expression multi-port valve extends to any water direction control assembly that may be used in relation to filtration in a pool or spa. Further, the expressions pool and spa extend to any similar body of water that required active filtration.

The pump strainer basket 61 in turn abuts the impeller 62. Removal of the pump (motor and impeller) is clearly straight forward. The pump strainer basket 61 is removed, connecting pipe 67 released and pump slid out. Other assemblies may be envisaged to provide similar ready access.

The recess preferably has a floor for supporting the pump. The floor may be integrally formed in the support base or may be separately formed, such as a concrete slab. In operation, an operator may slide a conventional pool pump into and out of position in the recess. Suitable locking arrangements may be used to lock the pump in position.

The pump 60 is mounted in the recess 21 such that a section housing the pump strainer basket 61 and impeller 62 protrudes from the side of the support base 20. The remaining section of the pump 60, containing the motor, is housed inside the support base 20. The support base 20 may include an inspection hatch 24, or the support base 20 may be formed from two portions that snap together to allow access to the pump 60. Alternatively, the pump may be simply removed. Inlet pipe 11 and filter pipe 12 connect between a pool and the multi-port valve 50 and waste pipe 13 connects between the multi-port valve and a sewer or a storm water connection as is known in the art. An electrolytic cell 16 is downstream from the filter housing 30.

Walls of the support base may be solid or define a hollow between two spaced walls around the recess. The hollow may be filled with a sound dampening material such as expanded foam. Vents 24 are provided to allow dissipation of heat. The vents may be configured to reduce noise escape. This may involve use of one or more baffles in each vent passage. Alternatively or additionally, each vent passage may include at least one angular deviation. The vents are arranged to resist or prevent ingress of rain.

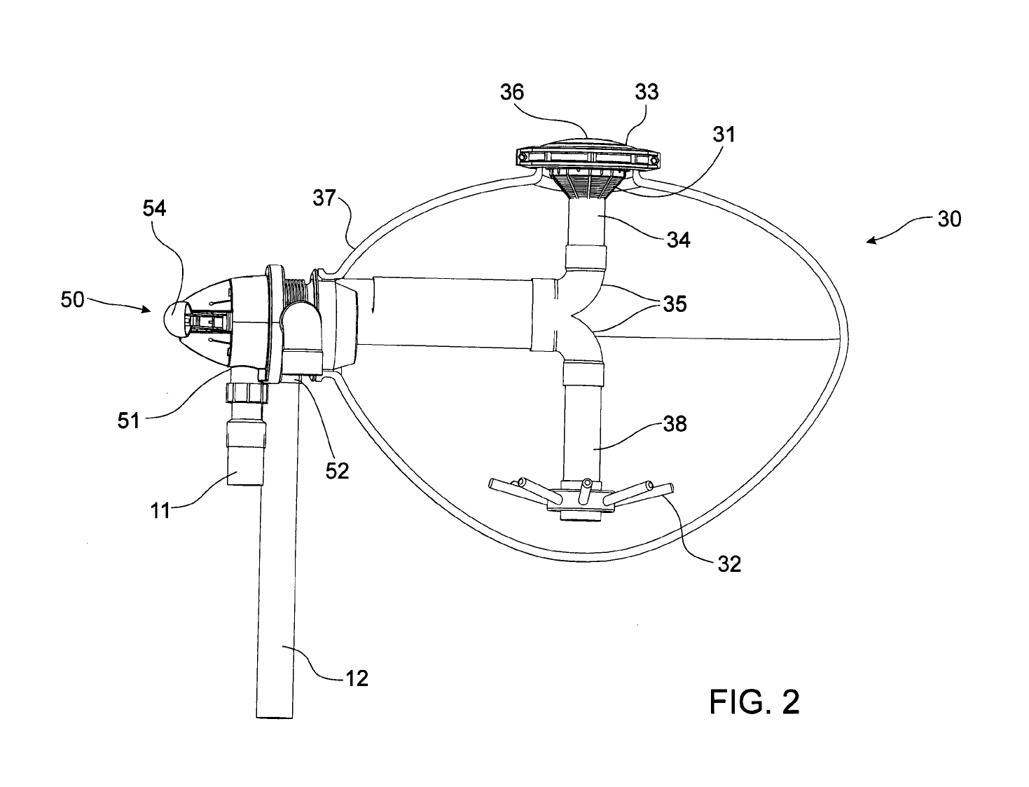

FIG. 2 shows a cut-away view of the filter housing 30. Although the present embodiment shows a media filter it should be appreciated that the filter could be any filter known in the art such as a cartridge filter or a centrifugal filter. It should also be understood that reference to “filter” in this specification includes the filter housing with or without its filtering component such as filter medium or cartridge, unless the context otherwise indicates. The filter housing 30 is substantially a prolate spheroid in shape and is mounted to the support base (not shown) with its major axis mounted horizontally and secured using snap-fittings, clasps or any other suitable securing mechanism. In some embodiments, the weight of the filter (including filter medium) is sufficient to provide stability. It should be appreciated that the filter housing 30 may be any shape such as a sphere, cube or a rectangular cuboid or variants thereof. The filter housing 30 is filled with sand, zeolite, fused silicon dioxide or any other applicable material (not shown). A particularly preferred medium is ground glass.

Internally, the filter housing 30 includes a diffuser 31 and lateral arms 32 connected by a series of pipes being an inlet pipe 34 and outlet pipe 38 and swept ninety degree bends 35. It should be noted that swept ninety degree bends 35 have been used rather than sharp ninety degree bends of the prior art, in order to improve the water flow through the filter 30 and to reduce stresses placed on the pipes by the passage of water. In filtering operation, water flows through inlet pipe 34 to diffuser 31 and is pressured through the filtering material. Cleaned water is collected by the lateral arms 32 and returned through an outlet pipe 38 to outside the filter housing.

The filter housing 30 of the present invention also includes a chemical port 33 connected to the diffuser 31 of the filter 30. The chemical port 33 allows an operator of the filtration unit to add pool chemicals, such as chlorine, acid and alkali, directly to the filter 30 in operation. The chemicals may be in a tablet form of a suitable shape and size in order to be inserted into the chemical port 33 by removing cap 36. In one arrangement the cross-section of the port may be a particular complex cross-section (such as a star) and correspond to the cross section of tablets of an appropriate chemical, to ensure compliance in chemical selection. Alternatively, the chemicals may be in the form of granules and/or liquid and added by using a suitable one-way valve in the chemical port 33. Adding the chemicals directly to the filter housing 30, may effectively enhance biocidal or biostatic activity against microbes such as bacteria that accumulate inside the filter, due to the higher concentration of chemicals.

The multi-port valve 50 is mounted to a side 37 of the filter 30 (i.e. a pointed end) however it should be appreciated that the multi-port valve 50 may be mounted on any other suitable surface of the filter 30 depending on the shape and design of filter. The multi-port valve 50 is mounted laterally to the filter 30 such that an orbital arm 54 may be operated in a substantially vertical plane. The multi-port valve 50 includes an inlet port 51, an outlet port 52 and a waste port (not shown) that are connected to inlet pipe 11, filter pipe 12 and waste pipe (not shown) respectively. The multi-port valve 50 operates in an identical manner to a multi-port valve known in the art by redirecting water through the various paths of the multi-port valve 50. Some modes of operation are:

1. Closed, where all ports are closed on the multi-port valve.

2. Filter, where the water is directed from the inlet port 51 to the outlet port 52 via the media in the filter 30.

3. Waste, where the water is directed from the inlet port 51 to the waste port.

4. Backwash, where the water is passed from the inlet port 51 to the waste port passing through the filter 30 from the lateral arms 32 to the diffuser 31.

5. Rinse, where the water is passed from the inlet port 51 to the waste port passing through the filter 30 between the diffuser 31 and the lateral arms 32 to compact the media in the filter after backwashing.

6. Recirculate, where the water is passed from the inlet port 51 directly to the filter port 52 without passing though the media in the filter 30.

The orbital arm 54 is moved in a substantially vertical plane between a plurality of positions wherein each position is a different mode of operation. Each mode may be separated by a notch, as would be known to a person skilled in the art. Furthermore, mounting the multi-port valve in this manner allows inlet pipe 11, filter pipe 12 and waste pipe to extend from the multi-port valve 50 vertically using fewer pipe connections than in the prior art. This enhances water flow, decreases components required and is aesthetically more visually appealing.

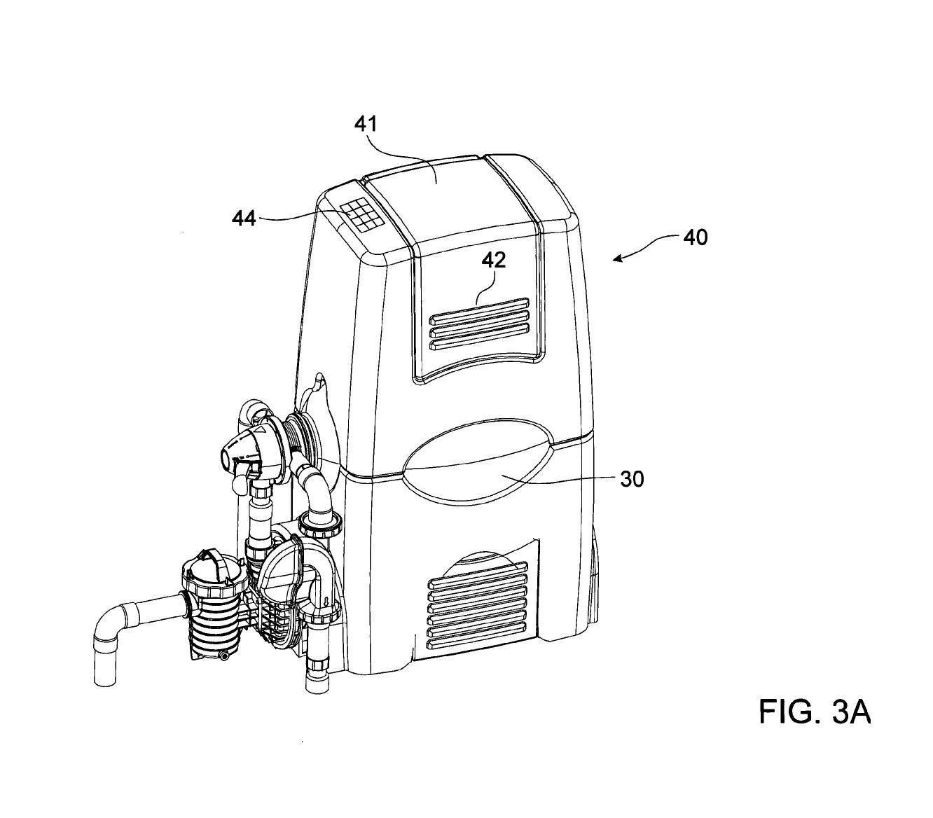

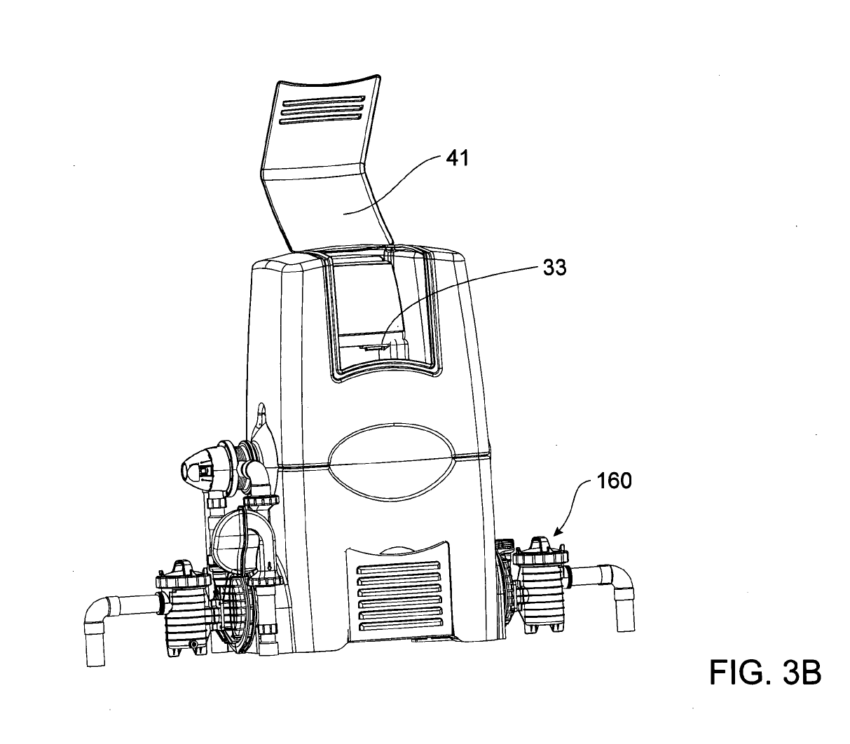

FIG. 3A shows an alternative embodiment of the filtration unit 10 including a top 40. The top 40 is also made from a plastic material and molded to accept the filter housing 30. The top 40 is mounted to cover the filter housing 30 and secured to either the support base 20 or the filter housing 30 using suitable snap-on connectors or any other suitable fixing mechanism. The top 40 may also include a hatch or door 41, pivotally connected to the top 40 as shown in FIG. 3B. The hatch or door 41 allows easy access to an inside of top 40 for storing chemicals and may optionally have a lock (not shown) for extra security. Furthermore, the inside of the top 40 serves as an access to a chemical port 33. Additionally, the top may accommodate controls for the pump 60, electronic pool testing apparatus, chlorinators, pool lights, solar heating controller, to name a few examples. In a preferred embodiment, the hatch provides access to a cabinet with a floor. The top is preferably formed from a chemical-resistant material so corrosive chemicals, such as hydrochloric acid, may be safely stored. The cabinet or if preferred cabinets, may include vents 42 to allow dissipation of volatised gases. The top may include two or more cabinets. The first cabinet may be adapted to receive hazardous chemicals while a second cabinet is isolated from the first and includes more sensitive equipment such as electronic controls, thermometers, solar heater controls and similar.

An electronic lock may be provided which can be released only under a complex protocol such as unlikely to be inadvertently performed by a child. This may include a keypad release 44, or require switching off of electricity to the unit by a remote switch in a safe location. The top and associated cabinets may be configured accordingly. The mere fact of storing the chemicals above the filter may decrease the chance of children accessing the chemicals. This is also enhanced if the filtration unit is positioned inside a pool safety fence. Alternatively or additionally, a mechanical lock or child-proof closure may be provided.

FIG. 3B shows the hatch open 41 allowing access to storage. It also shows a second pump 160 in position.

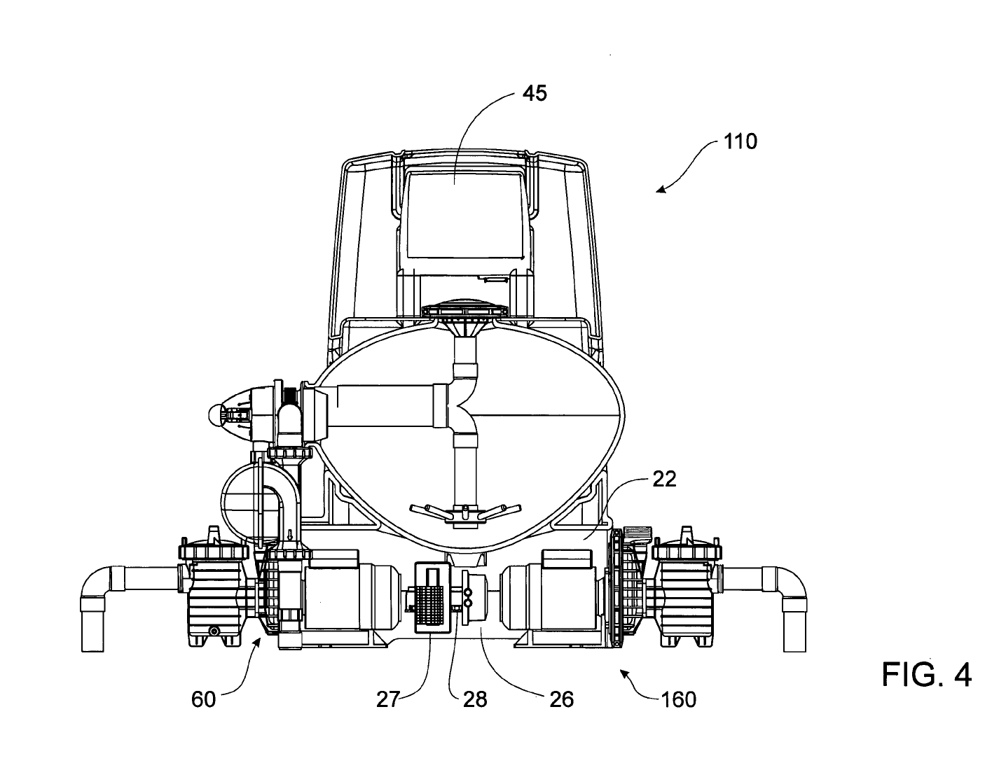

FIG. 4 shows a front sectional view of a filtration system 110 according to a further embodiment of the present invention including two pumps 60 and 160. In this embodiment a second recess 22 is formed in the support base 20 to accept the second pump 160. The second pump may be used in an auxiliary installation such as a solar heater. The recess and second recess may be continuous forming a single continuous tunnel 26. The single tunnel is preferably along a longitudinal axis of the support base. Space may be provided in this tunnel or indeed in the support base generally to house electronic components of the filtration unit such as transformers 27, circuit boards 28 and similar (not shown). This provides a highly protected environment for these sensitive components which may be accessible through an inspection hatch 24.

In a preferred embodiment, control of these electronic components is provided in or on the top cabinet for easy access by a user. The controls may be in the form of a touch pad 45 providing communication with programmable electronic controls as are known in the art. In operation, a user may simply open hatch 41 to provide visual and physical access to touch screen 45. The screen may be used to select different parameters such as temperature, pH, chlorine level, time of operation, and amperage of electrolytic cell. Some of these may be selectively variable to cause addition of chemicals or operation of heaters to better approach the desired and selected level.

Although an electrolytic cell is shown, the present invention is suitable for conventional chlorine fed pools.

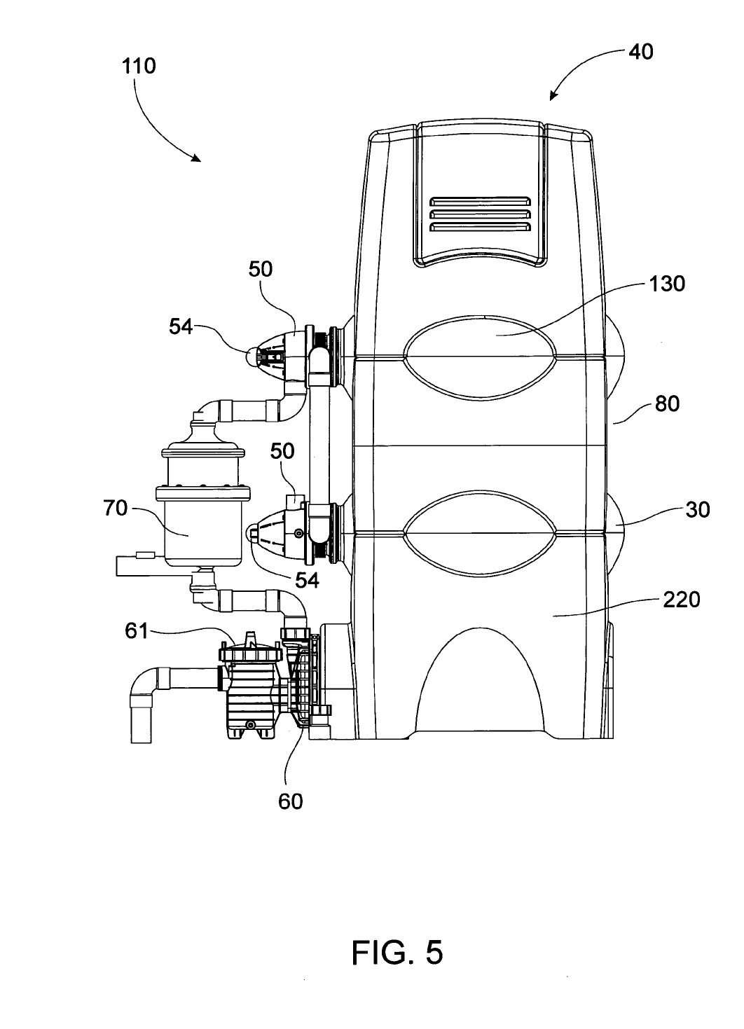

FIG. 5 shows a further embodiment of the present invention. In this embodiment, a second filter 130 is mounted above a first filter 30. A joining section 80 is moulded to accept each filter 30, 130. Furthermore, the joining section 80 may be secured to the support base 220 and the top 40 using a suitable connecting mechanism. Alternatively, the support base 220, joining section 80 and top 40 may be secured to a filter 30, 130. A centrifugal filter 70 is included in the filtration unit.

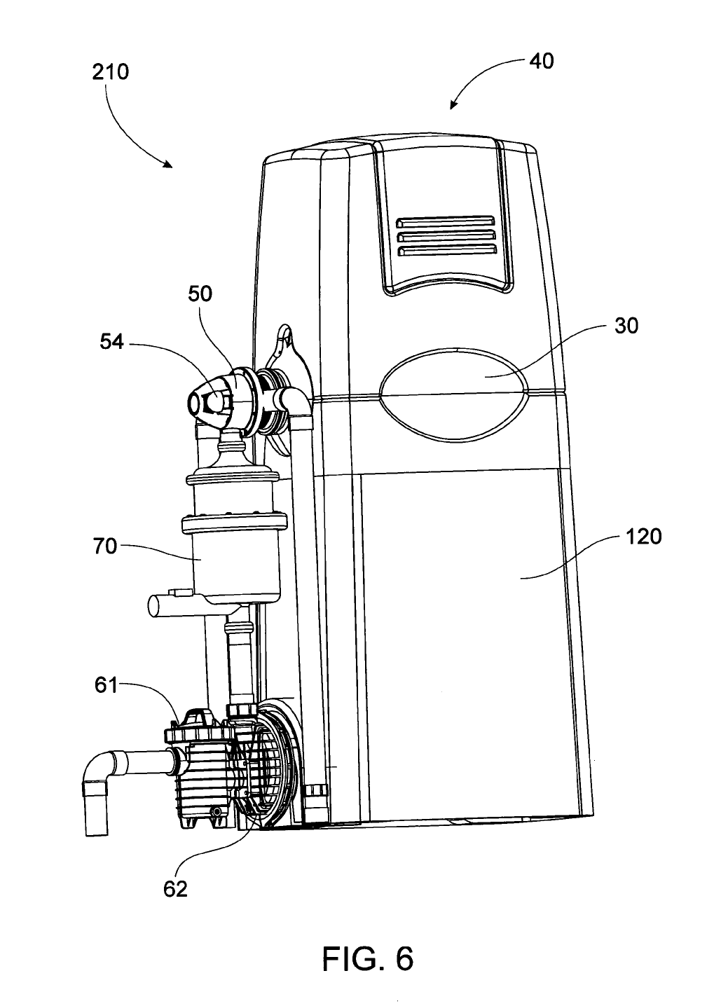

FIG. 6 is a front perspective view of a swimming pool filtration system according to a further embodiment of the present invention highlighting a centrifugal filter 70. The centrifugal filter 70 is connected between the pump 60 and the multi-port valve 50. A centrifugal filter is a device to channel water flow into a spiral flow creating a centrifugal force on sediment to spin it towards a wall of the filter. It descends to a collecting sump while cleaner water spirals upwards. The support base 120 is elongated vertically to accommodate the extra length of the space between the impeller 62 and valve 54.

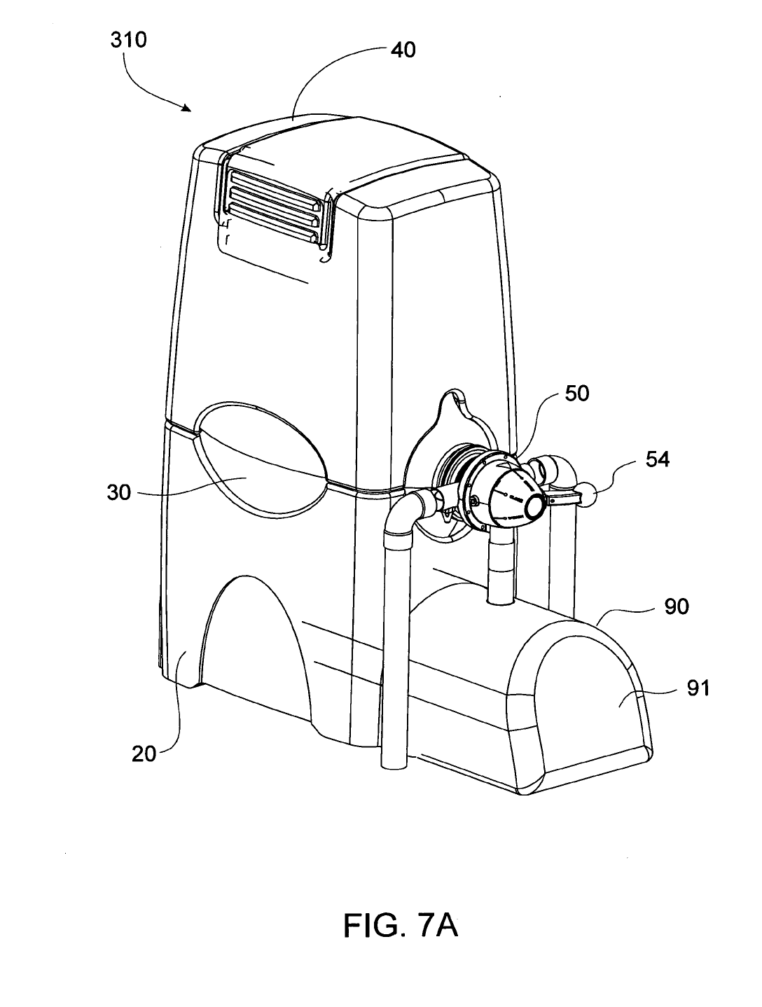

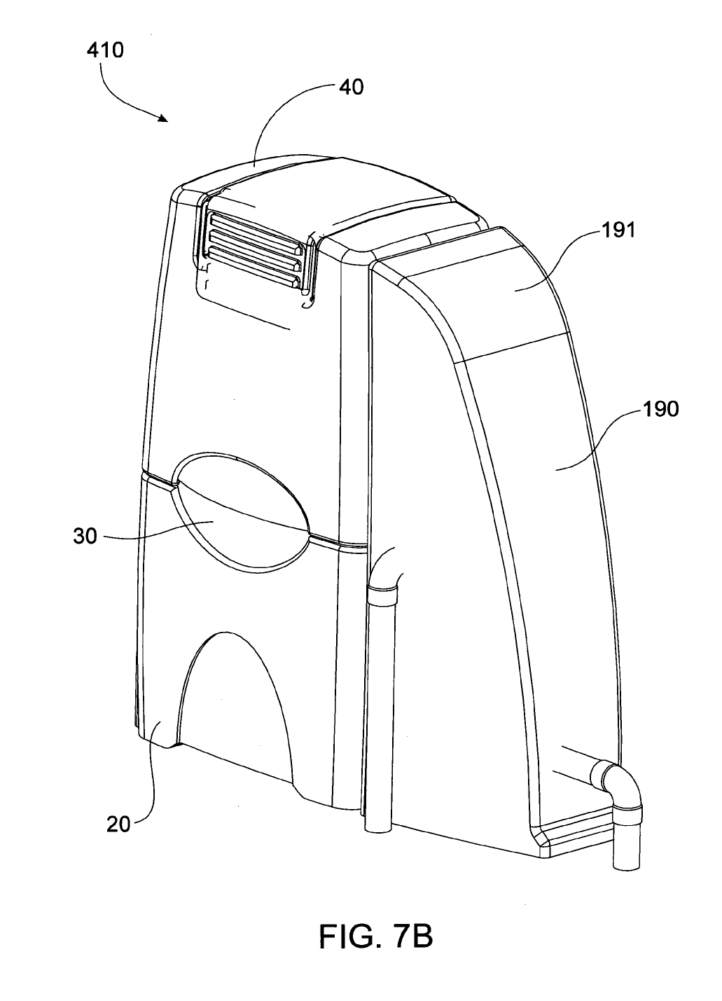

FIGS. 7A and 7B show embodiments including auxiliary covers 90,190 to conceal the pump filter, impeller and pipes, providing a highly aesthetically appealing finish. The auxiliary cover may be loosely fitted against support base 20. Preferably, it is positively attached by over centre locks, latched or any suitable arrangement allowing easy and ready access to the pump filter and pipes. The auxiliary cover may be formed integrally with the base and have a door 191 or be open 91 to provide access for installation and maintenance purposes.

There are many advantages of the present invention that may be summarised as follows:
1. the filtration unit may be supplied as a single part requiring fewer plumbing connections;
2. the support base provides protection for the motor of the pump from inclement weather and also suppresses noise from the motor;
3. top cabinets provide a convenient location for storing chemicals and housing swimming pool controls, lighting controls, chlorinators or other pool equipment. Furthermore, doors to the cabinets may be locked for added security;
4. by laterally mounting the multi-port valve the operating mode is easily changed compared with the prior art. Furthermore, lateral mounting of the multi-port valve facilitates ease of installation as all connections can be made on a single side of the filtration unit and any interconnecting pipes may be concealed by a cover.
5. a chemical port fitted to the filter allows chemicals to be added to the pool more safely and more conveniently;
6. the use of swept bends in the filter reduces the stresses placed on the filtration unit; and
7. the modular and stackable design allows for many permutations and combinations to be easily assembled.
8. the unit is aesthetically appealing and may be finished in neutral or selected colours.
9. unsightly filter arrangements and incongruous housing sheds are avoided.

Throughout the specification the aim has been to describe the preferred embodiments of the invention without limiting the invention to any one embodiment or specific collection of features. It will therefore be appreciated by those of skill in the art that, in light of the instant disclosure, various modifications and changes can be made in the particular embodiments exemplified without departing from the scope of the present invention.

1. A filtration unit for a swimming pool or spa, the filtration unit including:
a support base 20;
a filter housing 30 mounted on top of the support base; and
a recess 21 in the support base, the recess adapted to receive a pump 60, at least in part.

2. The filtration unit of claim 1 further comprising a multi-port valve 50 laterally mounted to the filter housing wherein an orbital control arm 54 of the multi-port valve may be moved in a substantially vertical plane to select alternative operations of the filtration unit.

3. The filtration unit of either claim 1 or claim 2 further comprising at least one pump 60 mounted to or positioned in the support base, the at least one pump in fluid communication with the filter housing.

4. The filtration unit of claim 1 wherein the support base is formed from one or more of polypropylene, polyethylene; acrylonitrile butadiene styrene and fibre-glass.

5. The filtration unit of claim 1 further including a top 40 positioned or above the filter housing 30.

6. The filtration unit of claim 5 wherein the top includes one or more cabinets.

7. The filtration unit of claim 6 wherein at least one of one or more cabinets has a door or hatch 41.

8. The filtration unit of claim 7 wherein the door or doors 41 includes a lock.

9. The filtration unit of claim 8 wherein the lock is electronically operated.

10. The filtration unit of claim 1 wherein the filter housing is substantially a prolate spheroid in shape.

11. The filtration unit of claim 1 further comprising an auxiliary cover 90 to cover components external to the support base.

12. The filtration unit of claim 1 further comprising a cyclonic filter 70 in fluid communication with the filter housing and adapted to communicate with a pump.

13. The filtration unit of claim 1 wherein the filter housing includes a chemical port 33 to allow direct addition of chemicals into the filter housing.

14. The filtration unit of claim 13 wherein the chemical port has a selected cross-section adapted to conform to a cross-sectional shape of a tabletised chemical.

15. The filtration unit of claim 1 comprising more than one filter housing wherein each filter housing is connected to an adjacent filter housing by a joining section 80 to provide fluid communication therebetween.

16. The filtration unit of claim 1 further comprising a second recess 22 adapted to receive a second pump, at least in part, the second pump adapted for use in a secondary function.

17. The filtration unit of claim 1 wherein the recess and second recess are continuous and form a single tunnel 26.

18. The filtration unit of claim 1 further comprising:
electronic components 27,28 of the filtration system in the support base; and
controls for the electronic components, in electrical communication with said controls, located in or on the top.

19. A method of decreasing external noise, at least in part, of one more pumps in a filtration arrangement for a swimming pool or spa, the method including the steps of:,
positioning the one or more pumps, at least partially, within a recess or recesses in a support base; and
locating a housing for a filtration medium above and supported by the support base.

20. A support base for a filtration unit for a swimming pool or spa, the support base comprising:
a body;
at least one recess in the body, the at least one recess dimensioned to receive a pump or part thereof; and
an upper cradle, said cradle adapted to receive a filter housing.
